(19) United States
(12) Patent Application Publication
(10) Pub. No.: US 2008/0049452 A1
(43) Pub. Date: Feb. 28, 2008

(54) Ultralow Power stan-By Supply

(75) Inventor: Tijimen Cornelis Van Bodegraven, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/577,830

(22) PCT Filed: Oct. 25, 2005
(86) PCT No.: PCT/IB05/53492

§ 371 Date: Apr. 24, 2007

(30) Foreign Application Priority Data
Oct. 28, 2004 (EP) 04105355.4

(51) Int. Cl. H02M 3/335

(52) U.S. Cl. 363/21.01

(57) ABSTRACT

A switched mode power supply is equipped with an auxiliary voltage supply (6; 60) supplying electrical energy to a controller (5; 50), which controls the switching of a switching transistor (4; 40). The auxiliary voltage supply (6; 60) receives a feedback signal from a feedback device (7; 70), which is coupled, to the output (2) of the power supply. In accordance with this feedback signal, the auxiliary voltage supply is arranged to reduce its supply of electrical energy to the controller in response to a decrease of the load at the output of the power supply, thereby reducing power dissipation in the power supply during low loading conditions.

### TECHNICAL FIELD OF THE INVENTION

The present invention relates to a switched mode power supply for conversion of an input voltage into at least one output voltage, and further to a method for supplying electrical energy to at least a portion of electric circuitry in such a switched mode power supply.

### BACKGROUND OF THE INVENTION

Switched mode power supplies are used in a wide range of electronic equipment. Examples of such electronic equipment include computing equipment, television and video equipment as well as portable telecommunication devices. Switched mode power supplies convert a DC primary voltage, such as a battery voltage or a rectified AC mains voltage, into one or more secondary voltages.

The recent demand for efficient power supplies in consumer electronic equipment has resulted in various improvements to the switched mode power supplies. For example, television and computer monitors typically include power supplies, which are capable of operating in multiple modes. A switched mode power supply operating in standby mode switches at a fixed lower frequency and dissipates less power than a power supply operating in a normal operation mode. In standby mode, only a few essential devices, such as microprocessors and microcontrollers, are powered.

US 2003/0169606 A1 discloses a switched mode power supply for conversion of an input voltage into an output voltage, which comprises a transformer for transforming the input voltage into the output voltage, a switching device for periodically coupling the transformer to the input voltage, and a controller for controlling the switching of the switching device. Further, the switched mode power supply being disclosed includes a startup device for supplying electrical energy to the controller in a startup phase. The startup device is coupled to a primary voltage or to a standby voltage supply and it is bypassed by a bypass device. During startup of the power supply, the bypass device is open. After a successful startup, the bypass device will be closed, thereby reducing the dissipation in the startup device and hence increasing the overall energy efficiency of the power supply.

As seen from above, different ways are known from the prior art in which the power dissipation in a switched mode power supply may be lowered, such as operation in multiple modes and bypassing the start-up device. However, by an ever increasing demand for efficient low power consuming power supplies, there is a need for further improvements to the switched mode power supplies.

### SUMMARY OF THE INVENTION

It is an object of the present invention to provide a further improved switched mode power supply, which provides further reduction of power dissipation in the power supply.

This and other objects are achieved by the provision of a switched mode power supply according to claim 1 and a method for supplying electrical energy to at least a portion of electric circuitry in such a switched mode power supply according to claim 9. Preferred embodiments of the present invention are defined in the dependent claims.

More specifically, a switched mode power supply according to the present invention, for conversion of an input voltage into at least one output voltage, comprises an inductive device for transforming the input voltage present at at least one input of the power supply into the at least one output voltage provided at at least one output of the power supply, a switching device for periodically coupling the inductive device to the input voltage, and a controller coupled to the switching device for controlling the switching of the switching device. The inventive switched mode power supply is characterised by an auxiliary voltage supply for supplying electrical energy to at least the controller, and a feedback device coupled to the at least one output, which feedback device is arranged to provide a first signal corresponding to the output voltage to e.g. a stabilizer of the auxiliary voltage supply, wherein the stabilizer of the auxiliary voltage supply is arranged to reduce its supply of electrical energy, e.g. the voltage level, to the controller in response to an increase of the output voltage according to the first signal from the feedback device.

Typically, the inductive device is a transformer with a primary coil and a secondary coil, but may also have a simpler construction including e.g. only one inductive element.

As defined herein, the fact that two items, for example two devices or a device and a voltage, are “coupled” means that the items may be galvanically coupled, electromagnetically coupled (as through a transformer), optically coupled (as through an optocoupler), etc. Further, the items may already be galvanically coupled, but are said to be “coupled” or activated by means of e.g. a switch.

By “input” and “output”, respectively, is meant a part of the switched mode power supply circuit on the primary side of the inductive device and a part of the switched mode power supply circuit on the secondary side of the inductive device, respectively.

In order to reduce the power dissipation in a switched mode power supply further, as compared to prior art, it is according to the present invention suggested to reduce the supply of electrical energy, e.g. the voltage level of the auxiliary voltage supply, to the controller in the power supply in response to an increase of the output voltage according to said first signal from the feedback device. That is to say that when the load on the output is low, the energy supply from the auxiliary voltage supply to the controller is reduced so that the power losses in the control circuit may be minimized and, hence, the efficiency of the power supply is increased at low loading conditions.

According to one embodiment of the invention, the controller is arranged to receive a second signal from said feedback device, which second signal corresponds to the output voltage, wherein the controller is arranged to reduce the switching frequency of the switching device in response to an increase of the output voltage according to the second signal from the feedback device. The switching frequency is thus reduced at low output power, whereby the switching loss in the switching device decreases and hence the efficiency of the power supply is further increased. By using the same feedback device to feedback the first and the second signal to the auxiliary voltage supply and the controller, respectively, fewer components are needed.

According to another embodiment, the controller is arranged to receive said second signal via the auxiliary voltage supply. This solution allows a simple circuit design since only one signal path is needed for the two signals to the controller and the auxiliary voltage supply, respectively.

In another embodiment of the invention, the power supply further comprises a startup device for supplying electrical energy to at least the controller during a startup phase of the power supply, during which phase the output voltage of the power supply is unregulated, wherein the startup device is arranged to stop its supply of electrical energy to the controller after the startup phase. The power consumed in the startup device during normal operation of the power supply is further reduced in comparison to the prior art mentioned above, since the startup device stops it supply of electrical energy to the controller while the prior art solution due to current splitting only reduces the power contribution of the startup device.

In another embodiment, the startup device is arranged to receive a turn-off signal from said feedback device, which turn-off signal has at least a value which indicates that the output voltage is above a predetermined level, wherein the startup device is arranged to stop its supply of electrical energy to the controller upon detection of said value of the signal. Again, the same feedback device is used to feedback also the turn-off signal to the startup device, whereby components are saved. As soon as the startup device receives the turn-off signal it stops its supply of energy to the controller and, hence, is not active longer than necessary, whereby its power consumption is as small as possible.

In another embodiment, the turn-off signal corresponds to said first signal, i.e. the signals may be represented by the same voltage, or the same current may flow e.g. into the startup device and out from the auxiliary voltage supply. Since the turn-off signal and the first signal correspond, the feedback only needs to generate one signal for both the startup device and the auxiliary voltage supply.

In yet another embodiment, the controller is coupled to the input of the power supply and arranged to sense a variation of the input voltage, wherein the controller is arranged to reduce the switching frequency of the switching device in response to a sensed increase of the input voltage. According to this embodiment of the invention, the switching frequency is reduced at high input voltage, whereby the switching loss in the switching device further decreases and, hence, the efficiency of the power supply is further increased.

In still another embodiment of the invention, the auxiliary voltage supply is coupled to the inductive device in order to receive power therefrom. Thereby, high efficiency in the energy supply may be achieved.

According to another aspect of the present invention, a method of supplying electrical energy to at least a portion of electric circuitry in a switched mode power supply, the switched mode power supply comprising an inductive device for transforming an input voltage into an output voltage, is characterised by supplying electrical energy to said portion of electric circuitry from an auxiliary voltage supply, providing a signal corresponding to the output voltage to the auxiliary voltage supply from a feedback device being coupled to an output of the power supply, and reducing the supply of electrical energy from the auxiliary voltage supply to said portion of electric circuitry in response to an increase of the output voltage according to the signal from the feedback device. As explained above in relation to the inventive power supply, the efficiency of the power supply is according to this method increased at low loading conditions.

Further features of, and advantages with, the present invention will become apparent when studying the appended claims and the following description.

### BRIEF DESCRIPTION OF THE DRAWINGS

The present invention will now be described in more detail with reference to the accompanying drawings, in which

FIG. 1 is a schematic block diagram illustrating the general layout of one embodiment of a switched mode power supply according to the present invention;

FIG. 2 is a schematic electrical circuit diagram in accordance with the embodiment of FIG. 1, which in an exemplary way shows some of the components of the switched mode power supply in more detail;

FIG. 3 is a schematic electrical circuit diagram showing one example of an auxiliary voltage supply suitable in the embodiment shown in FIG. 1 or 2;

FIG. 4 is a schematic electrical circuit diagram showing one example of a feedback device suitable in the embodiment shown in FIG. 1 or 2;

FIG. 5 is a schematic electrical circuit diagram showing one example of startup device suitable in the embodiment shown in FIG. 1 or 2;

FIG. 6 is a schematic electrical circuit diagram showing one example of a peak current limiter suitable in the embodiment shown in FIG. 1 or 2.

### DETAILED DESCRIPTION OF PREFERRED EMBODIMENTS

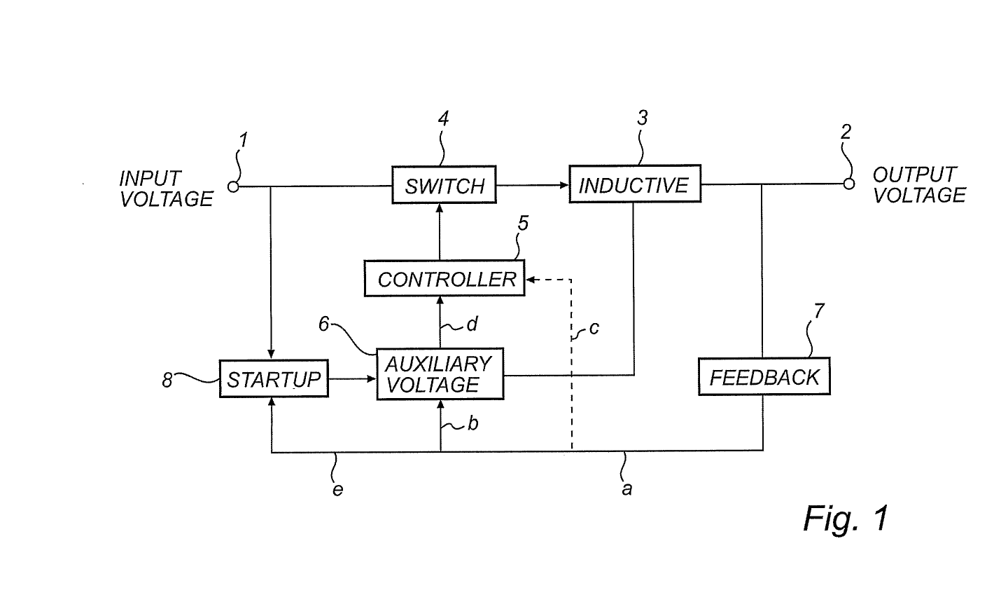

In FIG. 1, the general layout of one embodiment of a switched mode power supply according to the present invention is shown.

The switched mode power supply converts a DC input voltage applied at terminal 1 into a DC output voltage at terminal 2. Terminal 1 is coupled to a power stage comprising an inductive device 3 and a switching device 4, while the output of the power stage is coupled to terminal 2. A controller 5, which may comprise an integrated circuit device or discrete circuit components, controls the switching of the switching device 4.

An auxiliary voltage supply 6 supplies electrical energy to the controller 5 during normal operation of the switched mode power supply. The auxiliary voltage supply 6 is coupled to a feedback device 7, which in turn is coupled to the output terminal 2. The feedback device 7 is arranged to provide a first signal corresponding to the output voltage at terminal 2 to the auxiliary voltage supply 6 via a signal path a and b. In accordance with the first signal from the feedback device 7, the auxiliary voltage supply 6 is arranged to vary its supply of electrical energy to the controller 5.

The feedback device 7 is further arranged to provide a second signal corresponding to the output voltage at terminal 2 to the controller 5. The second signal may follow a direct signal path a and c, but is preferably provided to the controller 5 via signal path a, b, the auxiliary voltage supply 6 and d. Thereby, a simple circuit design is achieved since only one signal path is needed for the two signals to the controller 5 and to the auxiliary voltage supply 6, respectively. However, it is appreciated that the second signal may also follow another signal path, different from the one through the auxiliary voltage supply 6. In accordance with the second signal from the feedback device 7, the controller 5 is arranged to vary the switching frequency of the switching device 4.

The switched mode power supply in FIG. 1 further includes a startup device 8 which is arranged to supply electrical energy to the controller 5 during a startup phase of the power supply, during which phase the output voltage of the power supply is unregulated. In this embodiment, the startup device 8 is connected to the input terminal 1. However, the startup device may be connected to another source of electrical energy, such as a separate standby voltage supply, instead of the power supply input terminal. In this embodiment, the energy supply path from the startup device 8 to the controller 5 is via the auxiliary voltage supply 6.

The startup device 8 is also arranged to receive a signal from the feedback device 7—a turn-off signal which follows a signal path a and e. The turn-off signal has a value which indicates that the output voltage is above a predetermined level, and the startup device 8 is arranged to stop its supply of electrical energy to the controller 5 upon detection of said value of the turn-off signal. Preferably, the turn-off signal corresponds to the first signal provided to the auxiliary voltage supply 6, so that the feedback device 7 only has to generate one signal for both the auxiliary voltage supply 6 and the startup device 8. In fact, in this embodiment also the second signal to the controller 5 varies in accordance with the first signal to the auxiliary voltage supply 6, so that the feedback device 7 only has to generate one signal for the auxiliary voltage supply 6, the startup device 8 and the controller 5.

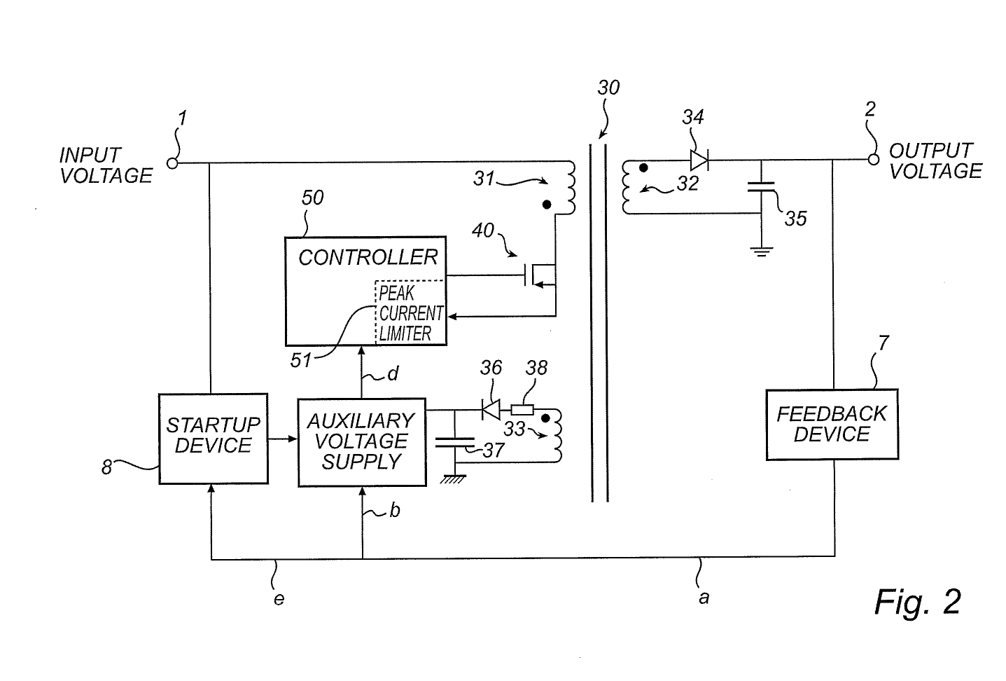

FIG. 2 shows a switched mode power supply in accordance with the embodiment of FIG. 1, where some of the components of the power supply are shown in more detail in an exemplary way.

As shown in FIG. 2, the inductive device is in the form of a transformer 30, having a primary winding 31 and a secondary winding 32. The primary winding 31 is coupled to a switching device in the form of a switching transistor 40 of a Field Effect Transistor (FET) type. At the secondary winding 32 of the transformer, electrical pulses are rectified and filtered by a rectifying diode 34 and a capacitor 35. In this embodiment, the switched mode power supply is arranged to function as fly-back converter. However, the invention is applicable to other types of converters as well, such as a step-up converter, a feed-forward converter, a buck converter, a boost converter, etc.

A tertiary winding 33 of the transformer 30 supplies electrical energy to the auxiliary voltage supply 6 via a resistor 38, a rectifying diode 36 and a filtering capacitor 37. Accordingly, in the present embodiment, the auxiliary voltage supply is coupled to the inductive device for receiving electrical energy during normal operation of the switched mode power supply. This is advantageous because it gives a voltage supply with small power losses and hence a high efficiency. Further, due to the usually large difference in voltage potential between the input and the auxiliary voltage supply and the significantly lower voltage potential provided by the tertiary winding, the auxiliary voltage supply being coupled to the inductive device makes it possible to supply electrical energy to the controller with a high efficiency as compared to providing the electrical energy from the input side of the power supply. However, according to the invention, the auxiliary voltage supply circuitry may also be connected to another part of the output, to a primary voltage, to a separate stand-by voltage supply, etc.

In the embodiment shown in FIG. 2, the controller 50 includes a peak current limiter 51, which is arranged to switch off the switching transistor 40 when the current through the switching transistor 40 exceeds a certain level. Thereby, the peak current limiter 51 protects the switching transistor 40 against damaging currents flowing through the transistor due to e.g. an unforeseen increase in the input voltage applied at terminal 1. The controller 50 is, via the switching transistor 40 and the peak current limiter 51, coupled to the input of the power supply and arranged to sense a variation of the input voltage at terminal 1 and vary the switching frequency of the switching transistor 40 in response to a variation of the input voltage.

The peak current limiter, which in this embodiment is included in the controller, may alternatively be a unit separate from the controller.

Referring to FIG. 2, when starting the switched mode power supply, the controller 5 is supplied with electrical energy via the startup device 8 from the input terminal 1. The controller 5 starts a periodic switching of the switching transistor 40 by supplying electrical drive pulses to the switching transistor 40.

As soon as the switching transistor 40 starts to switch, electromagnetic energy builds up in the tertiary winding 33, whereby the auxiliary voltage supply 6 starts to supply electric energy to the controller 50 as well. However, if during start-up the power supply is able to build up a secondary voltage which has a sufficiently high value, then the feedback device 7 will provide a turn-off signal to the startup device 8 via signal path a and e, and the startup device 8 will be turned off and hence stop its supply of electrical energy to the controller 50. Thereby, practically no power is consumed in the startup device 8 during normal operation of the power supply.

The electrical energy provided by the startup device 8 is not sufficient for continuous operation of the switched mode power supply. That is, after a certain amount of time, the startup device will not be able to provide enough electrical energy to the controller 5 in order to sustain normal operation of the power supply. This implies that if, during the start-up, the power supply is not able to build up a secondary voltage which has a sufficient high value, the feedback device 7 will not provide the turn-off signal and the power supply will continue to provide energy to the output just as long as the startup device can provide electrical energy to the controller. After a sufficiently long time of inactivity of the power supply, during which the startup device is charged, the startup device will make a new attempt of restarting the controller.

Under low loading conditions, i.e. when the power consumed at the output of the power supply is low, the voltage at terminal 2 will increase. This would be the case for example if the power supply is connected to a TV at the output terminal and the TV enters stand-by mode.

According to the invention, the auxiliary voltage supply 6 is arranged to reduce its supply of electrical energy to the controller 50 in response to such an increase of the output voltage. The increase of the output voltage is sensed by the auxiliary voltage supply 6 in the form of the first signal via signal path a and b from the feedback device 7.

Further, according to the second signal from the feedback device 7 via the signal path a, b, the auxiliary voltage supply 6 and d, the controller 50 is arranged to reduce the switching frequency of the switching device 40 in response to an increase of the output voltage. At higher output powers a higher switching frequency is needed in order to maintain the desired level of energy throughput. However, at lower output powers energy is saved by reducing the switching frequency.

As mentioned previously, the controller 50 is coupled to the input of the power supply and arranged to sense a variation of the input voltage at terminal 1 and vary the switching frequency of the switching transistor 40 in response to a variation of the input voltage. More specifically, the controller is arranged to reduce the switching frequency of the switching device in response to a sensed increase of the input voltage. At higher input voltages, a lower switching frequency is needed because the higher input voltage results in a larger energy throughput per time unit in the transformer 30 during each time that the switching transistor 40 couples the transformer to the input voltage. Hence, the transformer needs not to be coupled to the input voltage as often in order to maintain the same emery throughput, whereby the switching frequency may be lowered and the switching losses in the switching transistor may be further decreased.

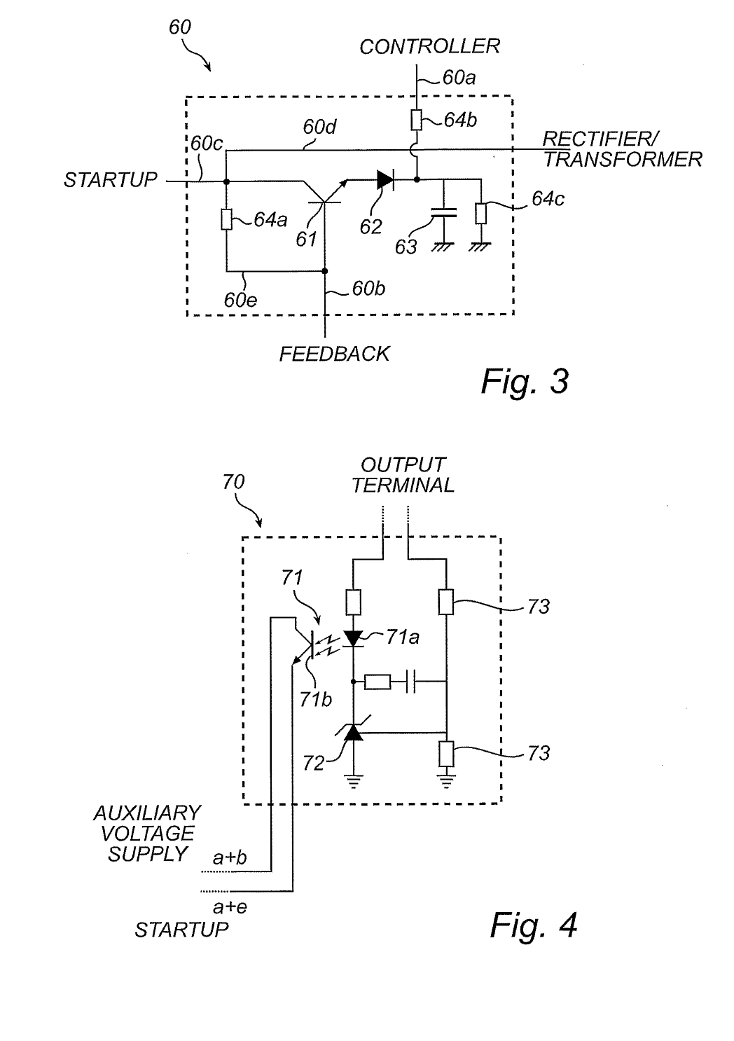

In FIG. 3, one example of an auxiliary voltage supply 60, which is suitable in the embodiment of FIG. 1, or 2 is shown. From the auxiliary voltage supply 60, one line 60a is connected to the controller, one line 60b is connected to the feedback device, one line 60c is connected to the startup device, and one line 60d is connected to the transformer and rectifier. In the main, the auxiliary voltage supply 60 comprises a linear regulator in the form of a transistor 61, a diode 62 and a capacitor 63. Resistors 64a-c are also included in the auxiliary voltage supply 60.

When the startup device is activated, a current will start to flow through the resistor 64a and line 60e, 60b, which current determines the current throughput in the transistor 61. A current will then start to flow via line 60c through the transistor 61 and diode 62, whereby the capacitor 63 is charged. When the voltage held by capacitor 63 has reached a certain level, the controller will be activated and start to draw a current in line 60a through the resistor 64b, whereby the voltage over capacitor 63 will start to reduce. However, as soon as the controller starts to operate, an electromagnetic field is built up in the tertiary winding of the transformer, whereby a current starts to flow from line 60d and recharge the capacitor 63. As soon as the feedback device starts to signal to the startup device that the output voltage from the power supply has reached a certain value, the startup device will be turned off and the controller will only be supplied by the auxiliary voltage supply 60, retrieving electrical energy from the transformer via line 60d.

If, during operation, the output voltage increases, which means that the load at the output is lower, the feedback device will draw a larger current—the first signal—through line 60b whereby, because of current division, the current flow in line 60e decreases and the current throughput in the transistor 61 decreases. Thereby, a reduction of the supply of electrical energy to the controller in response to an increase of the output voltage according to the first signal from the feedback device is achieved by the auxiliary voltage supply 60.

Indirectly, this reduction of the supply of electrical energy to the controller decreases the switching frequency of the switching device of the power supply. The “second signal” to the controller as mentioned above, is in this embodiment represented by the output voltage of transistor 61, i.e. the voltage across the junction of resistor 64b, capacitor 63 and resistor 64c. The controller is arranged to reduce the switching frequency of the switching device in response to an increase of the output voltage according to the decreased output voltage of transistor 61.

Referring now to FIG. 2 in combination with FIG. 3, the resistor 38 between the tertiary winding 33 and the diode 36 is arranged to reduce the voltage on the collector of the transistor 61 when the switching frequency of the switching device reduces. Because of the smaller ratio between the conducting time of the diode 36 and the total switching period, this resistor 38 will reduce the voltage on the collector of transistor 61. Due to the transistor 61 being in linear operation, the voltage reduction with this resistor 38 will cause less total power dissipation as compared to a corresponding voltage reduction by the transistor 61.

FIG. 4 shows an example of a feedback device 70, which is suitable in the embodiment of FIG. 1 or 2. The feedback device 70 comprises an optocoupler 71 including a light emitting diode (LED) 71a and an opto-regulated transistor 71b, the latter being connected at its collector to the auxiliary voltage supply and at its emitter to the startup device. Further, the feedback device 70 comprises a shunt regulator 72 and voltage dividing resistors 73. The output voltage at the output terminal is divided by the voltage dividing resistors 73 in order to provide a suitable reference voltage to the shunt regulator 72. When the output voltage at the output terminal reaches a certain value, the shunt regulator 72 will start to conduct in its back-direction and a current will start to flow through the LED 71a, whereby a current starts to flow through the opto-regulated transistor 71b, which current represents the first signal to the auxiliary voltage supply and the turn-off signal to the startup device.

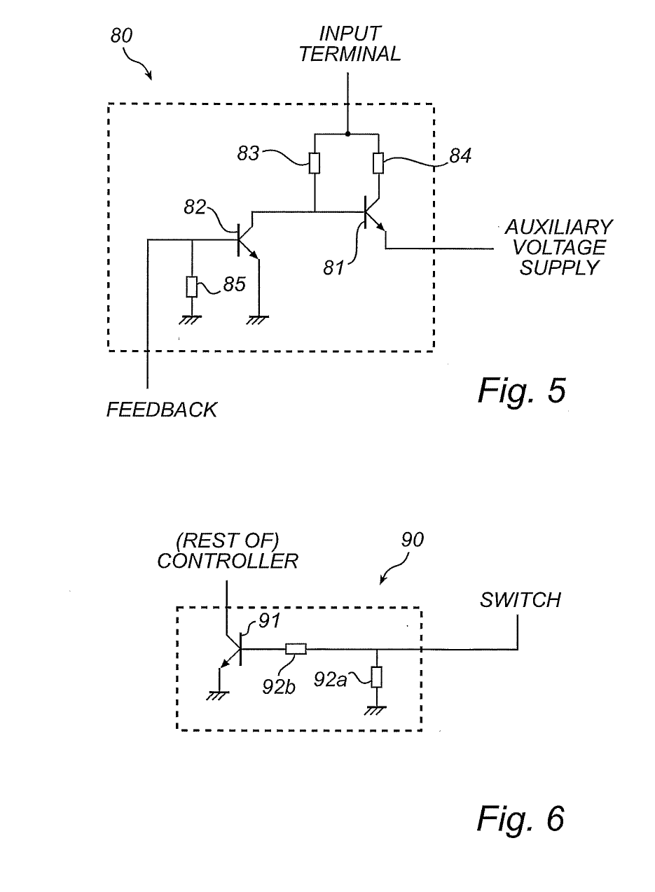

FIG. 5 shows a startup device 80 comprising a first transistor 81, a second transistor 82, and resistors 83-85. The value of resistor 83 is much larger than that of resistor 84. When an input voltage is applied at the input terminal of the power supply, the first transistor 81 will start to conduct and a current will start to flow to the auxiliary voltage supply through the resistor 84 to charge capacitor 63 and activate the controller. As soon as the feedback device starts to signal to the startup device 80 that a certain output voltage at the output terminal of the power supply has been reached, the second transistor 82 is switched on, whereby the first transistor 81 will be switched off. When the first transistor 81 is switched off, no current will flow from the startup device 80 to the auxiliary voltage supply and the controller. Since the value of the resistor 83 is very large, the power consumed by the startup device 80 during normal operation of the power supply is negligible.

A startup device according to above could be used in a switched mode power supply independently of the present invention including the claimed auxiliary voltage supply. More specifically, a switched mode power supply for conversion of an input voltage into at least one output voltage, comprising an inductive device for transforming the input voltage present at at least one input of the power supply into the at least one output voltage provided at at least one output of the power supply, a switching device for periodically coupling the inductive device to the input voltage, and a controller coupled to the switching device for controlling the switching of the switching device, could then be characterised by a startup device for supplying electrical energy to at least the controller during a startup phase of the power supply, during which phase the output voltage of the power supply is unregulated, wherein the startup device is arranged to stop its supply of electrical energy to the controller after the startup phase. As mentioned above, the power consumed in such a startup device during normal operation of the power supply will be very low as the startup device totally stops it supply of electrical energy to the controller.

Such a startup device could preferably be arranged to receive a turn-off signal from a feedback device, which turn-off signal has at least a value which indicates that the output voltage is above a predetermined level, wherein the startup device is arranged to stop its supply of electrical energy to the controller upon detection of said value of the turn-off signal. As soon as the startup device receives the turn-off signal it stops its supply of energy to the controller, and is therefore not active longer than necessary, whereby its power consumption is as small as possible.

In FIG. 6, a peak current limiter 90 suitable as the peak current limiter 51 in the embodiment shown in FIG. 2 is shown. The peak current limiter 90 comprises a transistor 91 and voltage dividing resistors 92a,b. Each time the switching device of the power supply is switched on, the voltage at the junction between the resistors 92a,b will start to raise. When this voltage reaches a certain value, the transistor 91 will be switched on to allow the controller to switch off the switching device.

When the input voltage to the power supply increases, the current through the inductive device, the switching device and resistor 92a will increase more rapidly than at lower input voltage levels due to the well known current-voltage characteristics of the inductive device. The essentially fixed delay in the turn-on of the transistor 91 due to internal capacitances etc. will hence due to the more rapid increase in current through resistor 92a provide for a higher peak-current through the inductive device. This increase in peak-current and hence power throughput per switching cycle will lead to an increase in output voltage, which via the feedback device will reduce the auxiliary voltage supply voltage level and hence the switching frequency of the switching device in order to maintain the desired output voltage. The decrease in switching frequency decreases the switching losses in the switching transistor and, hence, increases the efficiency of the power supply.

It is to be understood that modifications of the above described systems and methods can be made by people skilled in the art without departing from the spirit and scope of the invention.

1. A switched mode power supply for conversion of an input voltage into at least one output voltage comprising:
an inductive device (3; 30) for transforming the input voltage present at at least one input (1) of the power supply into the at least one output voltage provided at at least one output (2) of the power supply,
a switching device (4; 40) for periodically coupling the inductive device (3; 30) to the input voltage,
a controller (5; 50) coupled to the switching device (4; 40) for controlling the switching of the switching device, characterized by
an auxiliary voltage supply (6; 60) for supplying electrical energy to at least the controller (5; 50), and
a feedback device (7; 70) coupled to the at least one output (2), which feedback device is arranged to provide a first signal corresponding to the output voltage to the auxiliary voltage supply (6; 60),
wherein the auxiliary voltage supply (6; 60) is arranged to reduce its supply of electrical energy to the controller (5; 50) in response to an increase of the output voltage according to the first signal from the feedback device (7; 70).

2. A power supply according to claim 1, wherein the controller (5; 50) is arranged to receive a second signal from said feedback device (7; 70), which second signal corresponds to the output voltage, and wherein the controller is arranged to reduce the switching frequency of the switching device (4; 40) in response to an increase of the output voltage according to the second signal from the feedback device.

3. A power supply according to claim 2, wherein the controller (5; 50) is arranged to receive said second signal via the auxiliary voltage supply (6; 60).

4. A power supply according to claim 1, further comprising a startup device (8; 80) for supplying electrical energy to at least the controller (5; 50) during a startup phase of the power supply, during which phase the output voltage of the power supply is unregulated, wherein the startup device is arranged to stop its supply of electrical energy to the controller after the startup phase.

5. A power supply according to claim 4, wherein the startup device (8; 80) is arranged to receive a turn-off signal from said feedback device (7; 70), which turn-off signal has at least a value which indicates that the output voltage is above a predetermined level, wherein the startup device is arranged to stop its supply of electrical energy to the controller (5; 50) upon detection of said value of the turn-off signal.

6. A power supply according to claim 5, wherein the turn-off signal corresponds to said first signal.

7. A power supply according to claim 1, wherein the controller (5; 50) is coupled to the input of the power supply and arranged to sense a variation of the input voltage, and wherein the controller is arranged to reduce the switching frequency of the switching device (4; 40) in response to a sensed increase of the input voltage.

8. A power supply according to claim 1, wherein the auxiliary voltage supply (6; 60) is coupled to the inductive device (3; 30) in order to receive power therefrom.

9. A method of supplying electrical energy to at least a portion of electric circuitry in a switched mode power supply, the switched mode power supply comprising an inductive device (3; 30) for transforming an input voltage into an output voltage, characterized in that
supplying electrical energy to said portion of electric circuitry from an auxiliary voltage supply (6; 60),
providing a signal corresponding to the output voltage to the auxiliary voltage supply (6; 60) from a feedback device (7; 70) being coupled to an output (2) of the power supply, and
reducing the supply of electrical energy from the auxiliary voltage supply (6; 60) to said portion of electrical circuitry in response to an increase of the output voltage according to the signal from the feedback device (7; 70).
